(19) United States
(12) Patent Application Publication
(10) Pub. No.: US 2023/0083444 A1
(43) Pub. Date: Mar. 16, 2023

(54) ADJUSTING DIGITAL PRESENTATION MATERIAL USING MACHINE LEARNING MODELS

(71) Applicant: International Business Machines Corporation, Armonk, NY (US)

(72) Inventors: Qiang Yao, Shanghai (CN); Jian Jun Wang, Xian (CN); Jonathan D. Dunne, Mulhuddart (IE); Ziqiumin Wang, Shanghai (CN); Fu Er Liu, Shanghai (CN)

(21) Appl. No.: 17/447,738

(22) Filed: Sep. 15, 2021

(51) Int. Cl. G06F 16/34; G06N 20/00; G06F 16/33; G06F 16/332

(52) U.S. Cl. CPC G06F 16/345; G06N 20/00; G06F 16/3334; G06F 16/3326

(57) ABSTRACT

A computer adjusts a set of presentation materials, comprising. The computer receives, from a source available to the computer, an initial set of presentation materials. The computer, in response to receiving the initial set of presentation materials, determines a reference presentation duration associated with initial set of presentation materials. The computer receives a target presentation duration from a target duration source available to the computer. The computer determines a presentation conversion value representing, at least in part, a ratio of the target presentation duration to the reference presentation duration. The computer applies a Machine Learning (ML) refactoring routine to revise the initial set of presentation materials in accordance, at least partially, with the presentation conversion value, thereby generating a refactored set of presentation materials having a revised conveyance duration substantially the same as the target duration.

### BACKGROUND

The present invention relates generally to the field of editing sets of presentation materials, and more specifically, to a system that uses Machine Learning (ML) models to revise prepared digital presentations according to available time.

When making a presentation in a collaborative environment, the time available for conveying the content of the presentation may change after the presentation material has been finalized. For a variety of reasons, including overruns of other presentations, delays due to environmental or technical difficulties, schedule adjustments, etc., the time available for a given presentation may change, requiring the speaker to revise the presentation. Although, in some cases, it may be possible to revise the presentation manually, effective manual editing is not feasible in all settings. It may, for example, be difficult to manually revise presentations that discuss complex topics and presentations with large amounts of content. It can even be difficult to manually revise presentations that discuss simple topics and even presentations with relatively small amounts of content, when only a short period during which to revise the presentation is available (e.g., such when revisions need to be made on the day a particular presentation is to be delivered, and in other settings where urgent changes are required).

### SUMMARY

In embodiments according to the present invention, a computer implemented method to adjust a set of presentation materials, including receiving, by a computer, from a source available to the computer, an initial set of presentation materials. The computer, in response to receiving the initial set of presentation materials, determining by the computer, a reference presentation duration associated therewith. The computer receives a target presentation duration from a target duration source available to the computer. The computer determines a presentation conversion value representing, at least in part, a ratio of the target presentation duration to the reference presentation duration. The computer applies a Machine Learning (ML) refactoring routine to revise the initial set of presentation materials in accordance, at least partially, with the presentation conversion value, thereby generating a refactored set of presentation materials having a revised conveyance duration substantially the same as the target duration. According to aspects of the invention, the initial set of presentation materials includes a corpus of presentation text. According to aspects of the invention, the refactoring routine includes applying to the corpus of presentation text, a Natural Language Processing (NLP) model trained to summarize text, thereby generating a presentation text summary. According to aspects of the invention, the refactored set of presentation materials includes the presentation text summary. According to aspects of the invention, the summary has a total word quantity based, at least in part, on a product of the presentation conversion value and a total word quantity of the presentation text. According to aspects of the invention, the revised conveyance duration is longer than the reference conveyance duration. According to aspects of the invention, the NLP model includes an abstractive summarization algorithm. According to aspects of the invention, the content includes an image. According to aspects of the invention, the refactoring routine includes identifying within the image, by the computer using a Machine Learning (ML) model available to the computer and trained to determine a domain relevance with regard to a domain associated with the initial set of presentation materials, a set of domain-relevant image portions having a domain relevance exceeding a domain relevance threshold with respect to the associated domain. According to aspects of the invention, in response to identifying the set of domain-relevant image portions, ranking the domain-relevant image portions in accordance with, at least partially, associated domain relevance, and generating a refactored image that includes a representation of the ranking, whereby the refactored set of presentation materials includes a representation of the ranking. According to aspects of the invention, the refactoring routine includes identifying, within the set of domain-relevant image portions, a focus group of most-domain-relevant portions having a quantity substantially equal to a product of the presentation conversion value and a total quantity of domain-relevant portions. According to aspects of the invention, the computer receives a presentation density value. According to aspects of the invention, the presentation conversion value further represents a product of the presentation density value and the ratio of the target presentation duration to the reference presentation duration, whereby the revised conveyance duration accommodates a discussion period within the target duration.

In another embodiment of the invention, a system to adjust a set of presentation materials, which includes a computer system comprising a computer readable storage medium having program instructions embodied therewith, the program instructions executable by a computer to cause the computer to receive, from a source available to the computer, an initial set of presentation materials; responsive to receiving the initial set of presentation materials, determining by the computer, a reference presentation duration associated therewith; receive a target presentation duration from a target duration source available to the computer; determine a presentation conversion value representing, at least in part, a ratio of the target presentation duration to the reference presentation duration; and apply a Machine Learning (ML) refactoring routine to revise the initial set of presentation materials in accordance, at least partially, with the presentation conversion value, thereby generating a refactored set of presentation materials having a revised conveyance duration substantially the same as the target duration.

In another embodiment of the invention, a computer program product to adjust a set of presentation materials, the computer program product comprising a computer readable storage medium having program instructions embodied therewith, the program instructions executable by a computer to cause the computer to receive, from a source available to the computer, an initial set of presentation materials; responsive to receiving the initial set of presentation materials, determining by the computer, a reference presentation duration associated therewith; receive a target presentation duration from a target duration source available to the computer; determine a presentation conversion value representing, at least in part, a ratio of the target presentation duration to the reference presentation duration; and apply a Machine Learning (ML) refactoring routine to revise the initial set of presentation materials in accordance, at least partially, with the presentation conversion value, thereby generating a refactored set of presentation materials having a revised conveyance duration substantially the same as the target duration.

The present disclosure recognizes and addresses the shortcomings and problems associated with revising presentations that discuss complex topics and presentations with large amounts of content.

The present disclosure recognizes and addresses the shortcomings and problems associated with revising presentations when only a short period during which to revise the presentation is available (e.g., such when revisions need to be made on the day a particular presentation is to be delivered, and in other settings where urgent changes are required).

Aspects of the present invention automatically generate revised presentation material that preserve the overall message of the reference presentation content.

Aspects of the present invention automatically generate revised presentation material refactored to reflect a ratio of a provided target presentation duration to the original, conveyance duration.

Aspects of the present invention automatically generate revised presentation material that accommodate a desired discussion period within a target presentation duration.

Aspects of the present invention automatically generate revised presentation material that accommodate a desired question & answer period within a target presentation duration.

Aspects of the present invention automatically generate revised presentation material that accommodate a target presentation duration that is shorter than an initial conveyance duration for a set of provided presentation material.

Aspects of the present invention automatically generate revised presentation material that accommodate a target presentation duration that is longer than an initial conveyance duration for a set of provided presentation material.

Aspects of the present invention automatically generate revised presentation material using a Natural Language Processing (NLP) model trained to generate a length-controlled summary of text within an initial set of presentation material. According to aspects of the invention, the summaries may be longer or shorter than an original passage of text, to accommodate an indicated target presentation duration.

Aspects of the present invention automatically generate revised presentation material using a Machine Language (ML) model to identify, rank, and indicate domain relevance of, objects within reference presentation material content images.

### BRIEF DESCRIPTION OF THE DRAWINGS

These and other objects, features and advantages of the present invention will become apparent from the following detailed description of illustrative embodiments thereof, which is to be read in connection with the accompanying drawings. The various features of the drawings are not to scale as the illustrations are for clarity in facilitating one skilled in the art in understanding the invention in conjunction with the detailed description. The drawings are set forth as below as:

FIG. 1 is a schematic block diagram illustrating an overview of a system for a computer implemented method of automatically adjusting presentation material to accommodate a target duration time different than a reference conveyance time.

FIG. 2 is a flowchart illustrating a method, implemented using the system shown in FIG. 1, of automatically adjusting presentation material to accommodate a target duration time different than a reference conveyance time.

FIG. 3 is a flowchart illustrating aspects of a method, implemented using the system shown in FIG. 1, of automatically adjusting presentation material to accommodate a target duration time different than a reference conveyance time.

FIG. 4A is a schematic representation of aspects of a text revision method implemented using the system shown in FIG. 1, of automatically adjusting presentation material to accommodate a target duration time different than a reference conveyance time.

FIG. 4B is a schematic representation of aspects of a text revision method implemented using the system shown in FIG. 1, of automatically adjusting presentation material to accommodate a target duration time different than a reference conveyance time.

FIG. 4C is a schematic representation of aspects of a text revision method implemented using the system shown in FIG. 1, of automatically adjusting presentation material to accommodate a target duration time different than a reference conveyance time.

FIG. 5A is a schematic representation of aspects of an image revision method implemented using the system shown in FIG. 1, of automatically adjusting presentation material to accommodate a target duration time different than a reference conveyance time.

FIG. 5B is a schematic representation of aspects of an image revision method implemented using the system shown in FIG. 1, of automatically adjusting presentation material to accommodate a target duration time different than a reference conveyance time.

FIG. 5C is a schematic representation of aspects of an image revision method implemented using the system shown in FIG. 1, of automatically adjusting presentation material to accommodate a target duration time different than a reference conveyance time.

FIG. 5D is a schematic representation of aspects of an image revision method implemented using the system shown in FIG. 1, of automatically adjusting presentation material to accommodate a target duration time different than a reference conveyance time.

FIG. 6 is a schematic representation of aspects of a revised conveyance duration reflecting a presentation density value that accommodates a discussion period within a target duration.

FIG. 7 is a schematic block diagram depicting a computer system according to an embodiment of the disclosure which may be incorporated, all or in part, in one or more computers or devices shown in FIG. 1, and cooperates with the systems and methods shown in FIG. 1.

FIG. 8 depicts a cloud computing environment according to an embodiment of the present invention.

FIG. 9 depicts abstraction model layers according to an embodiment of the present invention.

### DETAILED DESCRIPTION

The following description with reference to the accompanying drawings is provided to assist in a comprehensive understanding of exemplary embodiments of the invention as defined by the claims and their equivalents. It includes various specific details to assist in that understanding but these are to be regarded as merely exemplary. Accordingly, those of ordinary skill in the art will recognize that various changes and modifications of the embodiments described herein can be made without departing from the scope and spirit of the invention. In addition, descriptions of well-known functions and constructions may be omitted for clarity and conciseness.

The terms and words used in the following description and claims are not limited to the bibliographical meanings, but are merely used to enable a clear and consistent understanding of the invention. Accordingly, it should be apparent to those skilled in the art that the following description of exemplary embodiments of the present invention is provided for illustration purpose only and not for the purpose of limiting the invention as defined by the appended claims and their equivalents.

It is to be understood that the singular forms “a,” “an,” and “the” include plural referents unless the context clearly dictates otherwise. Thus, for example, reference to “a participant” includes reference to one or more of such participants unless the context clearly dictates otherwise.

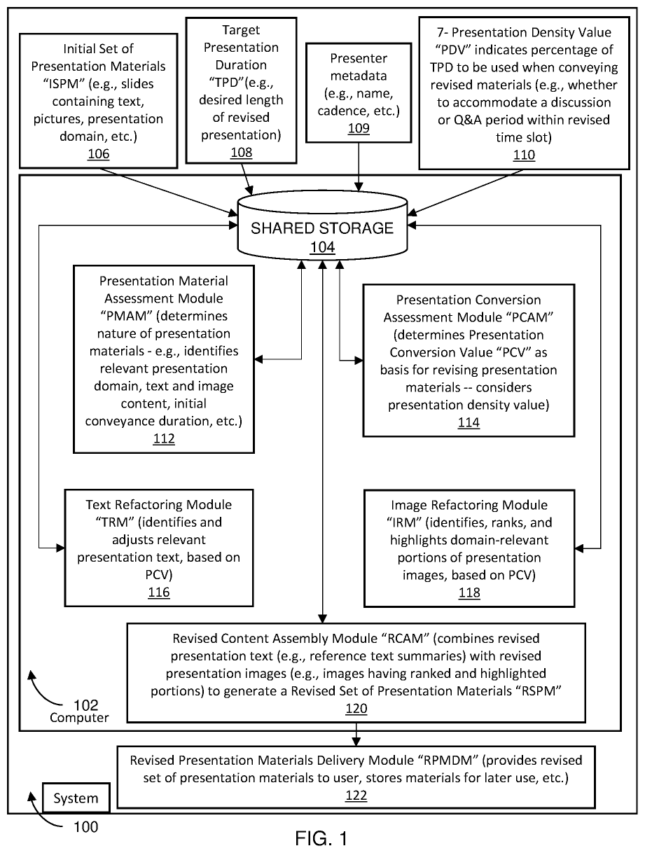

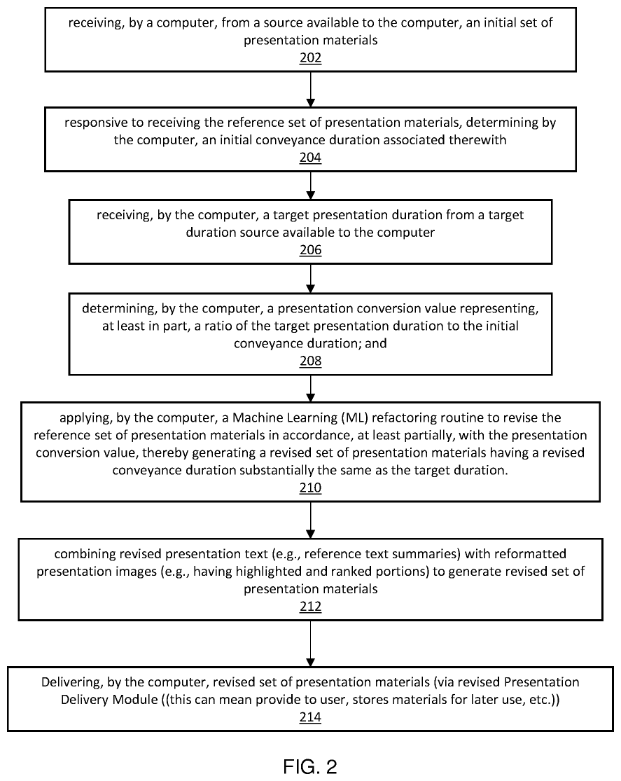

Now with combined reference to the Figures generally and with particular reference to FIG. 1 and FIG. 2, an overview of a method of adjusting a set of presentation material within a system 100 as carried out by a server computer 102 having optionally shared storage 104 is shown.

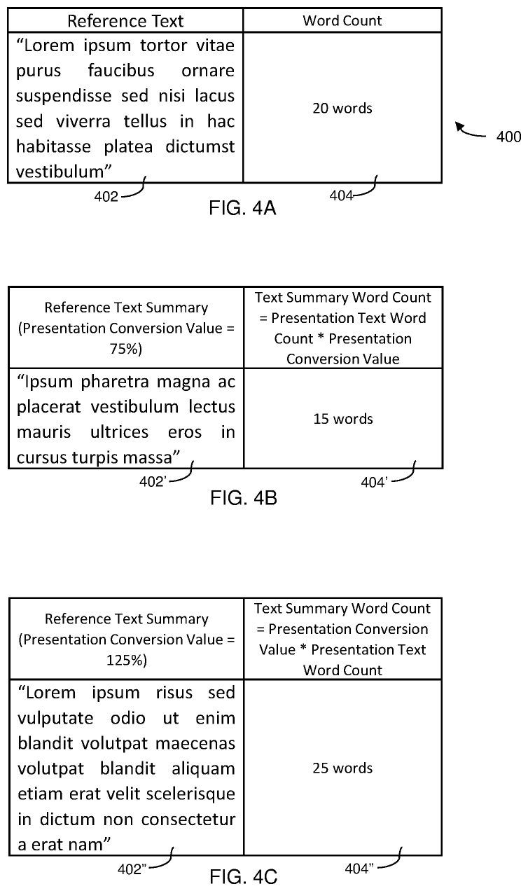

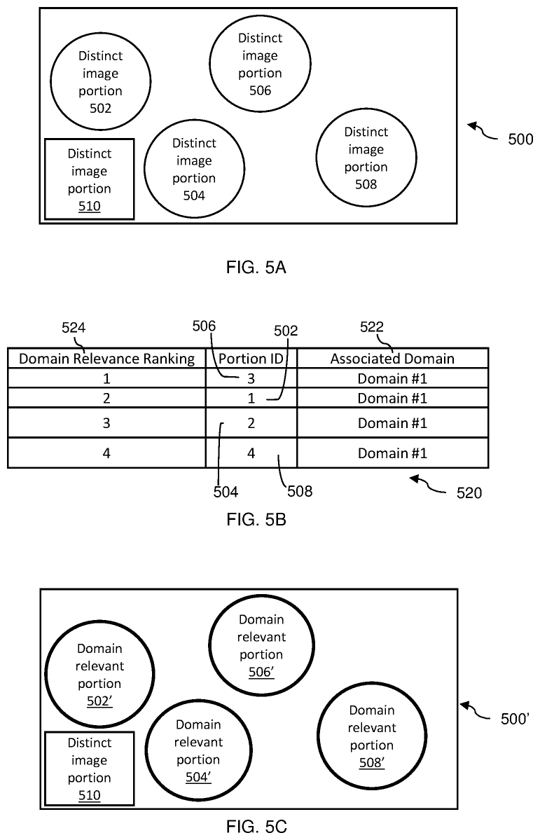

The server computer 102 receives an Initial Set of Presentation Material “ISPM” 106 in a format processable by the server computer, from a source available to the server computer. In some use cases, the ISPM 106 includes presentation slides or other content containing instances of reference text 402 (e.g., as represented schematically, along with a reference text word count 404, in reference text table 400 of FIG. 4A) and reference images 500 having various image portions 502, 504, 506, 508, 510 (e.g., as represented schematically in FIG. 5A).

It is noted that an Initial Set of Presentation Material “ISPM” 106 may include various combinations of reference text 402 and reference images 500 (e.g., the ISPM might include only one kind of content, might contain several instances of either kind of content, etc.), and the ISPM may also contain additional kinds of content suitable for presentation, as selected by one skilled in this field.

In one use case suitable for the present system 100, an ISPM 106 is prepared for conveyance by an identified presenter during an upcoming, predetermined time slot of known duration within a conference, business meeting, or other similar setting; after the ISPM content is finalized, the duration of the assigned time slot is changed to a such degree that effective presentation of the as-prepared ISPM is no longer realistic. Another use case may arise when an alternate speaker with a presentation style substantially different than that of the original speaker (e.g., much slower, much faster, etc.), is expected to present the as-prepared ISPM 106. If differences in presentation styles between the original speaker and the alternate speaker are sufficient (e.g., as determined by the server computer via assessment described more fully below), effective presentation of the as-prepared ISPM 106 during the assigned time slot may, as with the first use case, no longer be realistic.

According to aspects of the present invention, the server computer 102 will refactor an ISPM 106 to accommodate the above described situations and other similar use cases in which automatic revision of presentation material to match a presentation conveyance duration is desired. Aspects of the invention automatically revise an ISPM 106 from an initial format into a refactored format that is suitable for effective conveyance by a relevant presenter within a Target Presentation Duration “TPD” 108 received by the server computer 102 from a source in communication with the server computer. In particular, the server computer automatically adjusts an as-prepared ISPM 106 into a revised set of presentation material including revised text 402′, 402″ (e.g., shown schematically, along with associated revised word counts 404′, 404″, in FIGS. 4B and 4C) and revised image 500′ (e.g., shown schematically in FIG. 5C, in which domain-relevant image portions 502′, 504′, 506′, 508′ are identified).

According to aspects of the invention, the server computer 102 is in communication with a source of presenter metadata 109. It is noted that the server computer may also extract presenter metadata 109 from publicly available historic content available to the server computer. In an embodiment, presenter metadata 109 includes details about speaking characteristics for relevant presenters. In particular, presenter metadata 109 may include known speaking patterns, typical per-word speaking pace or cadence, number of words typically spoken to convey written words (e.g., a text ratio indicating whether the speaker reads slide text content verbatim, whether the speaker provides a general overview of slide text content, whether the speaker combines these approaches, etc.), length of time required to describe regions of importance within images of various sizes and composition, etc.). It is noted that, if metadata is missing for a given presenter, the server computer 102 will use an average value (or other value selected by one of skill in this filed) as a substitute for estimation purposes.

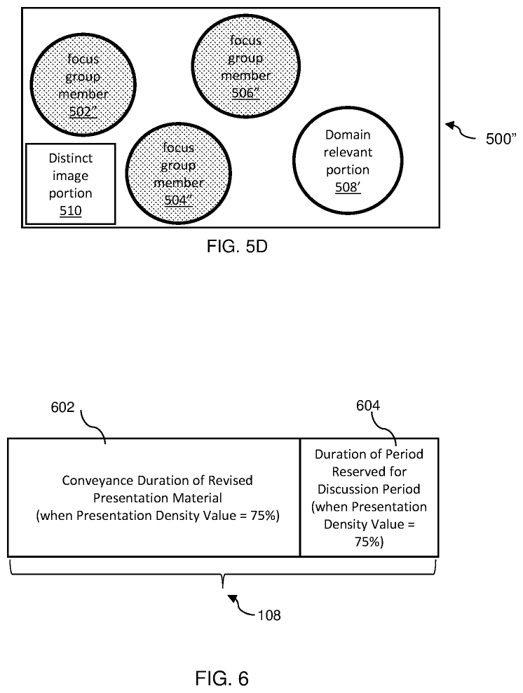

In an embodiment, the server computer 102 receives from a source in communication with the server computer, a preferred Presentation Density Value “PDV” 110 that indicates a percentage of the TPD 108 to be used by a presenter when conveying material revised according to the present invention. According to aspects of the invention, the PDV 110 impacts how the server computer 102 revises the ISPM 106 and, as indicated schematically in FIG. 6, how much (if any) time 604 is reserved for general discussion, conducting a Q&A period, etc., beyond the estimated time required 602 for conveyance of refactored material. Strategic selection of the PDV 108 allows a relevant presenter (or other associated stakeholder) to indicate whether revised presentation material should be revised in a manner that accommodates a discussion or Q&A period within the received TPD 108. Even if a speaker is able to effectively convey revised convent 402′, 402″, 500′ in an allotted TPD 108, It is noted that some topics may benefit from supplemental discussion and Q&A interaction, when an ISPM 106 is revised. By automatically accommodating discussion period or a Q&A session, aspects of the present invention are especially useful when refactoring presentation ISPM 106 for topics that may be difficult to cover adequately with a revised set of presentation material. It is noted that, if no explicit value for PDV 110 is provided, the server computer 102 applies a default PDV value of 100%.

The server computer 102 includes Presentation Material Assessment Module “PMAM” 112 that determines the nature of ISPM content, as will be described further below. In an embodiment, the PMAM 112 determines, for a given ISPM 106, using a Natural Language Processing (NLP) model available to the server computer, a relevant presentation domain 522 (e.g., a topic relevant to the ISPM, as represented schematically in the image portion domain relevance ranking table 520, shown in FIG. 5B), instances of reference text 402, discrete reference image portions 502, 504, 506, 508, 510, and an Initial Conveyance Duration “ICD” (e.g., an estimated time required for a selected presenter to convey the ISPM).

The server computer 102 includes Presentation Conversion Assessment Module “PCAM” 114 that determines a unitless Presentation Conversion Value “PCV” used by the server computer 102 when refactoring an ISPM 106, as described more fully below. In an embodiment, the PCAM 114 compares the ICD to the TPD 108 and calculates the PCV. In particular, the PCV is the ratio of the TPD to the ICD (e.g., PCV=TPD/ICD). As a clarifying, non-limiting example, if the PMAP 112 determines the ICD to be 120 minutes and the received TPD 108 is 60 minutes, the PCV is ½. According to aspects of the invention, the PDV 110 affects the PCV, and if the PDV is a value other than 100%, the PCAM 114 modifies the PCV accordingly (e.g., PCV=[(TPD/ICD)*PDV]). As a clarifying, non-limiting example, if the PMAP 112 determines the ICD is 120 minutes, the received TPD 108 is 60 minutes, and the indicated PDV is 75%, then PCV_{PDV}=[(60/120)*0.75]=0.375. It is noted that PCV and PCV_{PDV} are unitless and do not, by themselves, directly indicate duration; instead, the server computer uses PCV and PCV_{PDV} to generate revised text 502′, 502″ from reference text 500, as described more fully below. Through considering and accommodating the PDV when determining the PCV (e.g., PCV_{PDV}), aspects of the generate revised presentation material having a revised conveyance duration 602 substantially equivalent to a preselected portion of a target duration 108 ((e.g., as shown in FIG. 6).

The server computer 102 includes Text Refactoring Module “TRM” 116 that identifies and adjusts reference text 402, based on the PCV, to accommodate material conveyance during a received TPD 108. According to aspects of the invention, the TRM 116 generates, as will be described more fully below, reference text summaries 404′, 404″ (e.g., as represented schematically in FIGS. 4B and 4C). Based on the relationship among the TPD 108, ICD, and PDV 110 captured in the PCV, a reference text summary 402′ may be shorter than the reference text 402 (e.g., as shown in reference text summary table 400′ of FIG. 4B, where word count 404′ is smaller than the reference text word count 404). It is also noted that a reference text summary 402″ may be longer than the reference text 402 (e.g., as shown in reference text summary table 400″ of FIG. 4C, where word count 404″ is larger than the reference text word count 404).

The server computer 102 includes Image Refactoring Module “IRM” 118 that identifies, ranks, and highlights domain-related portions of reference images 500 to accommodate material conveyance during a received TPD 108. According to aspects of the invention, the IRM 118, identifies from among the image portions 502, 504, 506, 508, 510 identified by the PMAM 112, a set of image portions 502, 504, 506, 508 related to the domain 522 identified by PMAM (e.g., image portions having a domain relevance exceeding a similarity threshold, as determined by a Machine Learning (ML) classification, clustering, or similar grouping model selected by one skilled in this field, and represented schematically in FIG. 5A). According to aspects of the invention, the IRM 118 ranks the domain-related image portions 502, 504, 506, 508 according to a degree of domain relevance 524 (e.g., as represented schematically in the domain relevance table 520 of FIG. 5B). According to aspects of the invention, the IRM 118 updates the image 500 with a representation of the domain-related image portion rankings (e.g., such as by including table 520 into a notes section (not shown) for the image 500, by including a first level of highlighting to domain-related image portions 502′, 504′, 506′, 508′, or by adopting an method selected by one of skill in this field). In an embodiment, the IRM 118 generates a revised image 500′ in which a focus group of key image portions (e.g., a top-k ranked set 502′, 504′, 506′ of highest-ranked, domain-related portions) is identified (e.g., such as by adding a second level of highlighting to the focus group of image portions 502″, 504″, 506″, such as hashing or other identification cues selected by one of skill in this field). According to aspects of the invention, the size of the focus group (e.g., the most-relevant of domain-related image portions) is based, at least in part, on the PCV. In particular, the quantity of portions included in the focus group (e.g., the k value used in a top-k selection routine) is the product of the PCV and total number of domain-related image portions (e.g., [k=(PCV*number of domain related image portions)]. As an exemplary, non-limiting example, if an image includes four domain-related portions 502, 504, 506, 508) and the PCV is ¾, the quantity k of members in the focus group 502″, 504″, 506″ is three (as shown schematically in revised image 500″ of FIG. 5D). According to aspects of the invention, identifying the focus group members 502″, 504″, 506″ allows a presenter to emphasize key portions of revised image content, while still meeting the time constraints established by the TPD. According to aspects of the invention and as shown schematically with combined reference to FIG. 5D and FIG. 6, with strategic selection of a PDV 110, the server computer 102 will automatically generate a presentation that allows a presenter to include highlighted areas of focus 502″, 504″, 506″ during structured presentation 602, while providing time 604 to discuss (or answer questions about) other items, such as domain-relevant image portions 508′ outside the focus group or other topics, as presenter judgment dictates.

The server computer 102 includes Refactored Content Assembly Module “RCAM” 126 that combines refactored presentation text 402′, 402″ (e.g., reference text summaries) with reformatted presentation images 502′, 502″(e.g., images having ranked and highlighted portions) to generate a Revised Set of Presentation Material “RSPM”.

The server computer 102 is in communication with Revised Presentation Material Delivery Module “RPMDM” 122 that provides revised sets of presentation material “RSPM” to presenters or other users, stores the material for later use, etc. According to aspects of the invention, the RPMDM 122 may be a user interface, storage device, or other transference device selected by one of skill in this field.

Now with specific reference to FIG. 2, and to other figures generally, a computer implemented method of automatically adjusting presentation material to accommodate a duration different than an initial conveyance duration using the system 100 will be discussed. The server computer 102 receives at block 202, from a source available to the computer, an Initial Set of Presentation Material ISPM 106. According to aspects of the invention, this material 106 may include electronic files containing text and graphics, in various combinations, and in a variety of formats (e.g., written text, slideshow presentations, collections of images with and without annotation, and other material prepared or collected in support of conveying a message related to a particular domain (e.g., an area of interest or topics of focus) associated with the presentation. According to aspects of the invention, an indication of one or more relevant presentation domain 522 may be provided with the initial set of material be included domain relevant. According to other aspects of the invention, the server computer 102 via PMAM 112 uses a Natural Language Processing (NLP) topic identification model to identify a presentation-relevant domain 522. It is noted that suitable topic identification methods include bag-of-words analysis and term frequency-inverse document frequency (Tf-idf) analysis combined with the natural language toolkit (NLTK) associated with the Python computer language, although other suitable methods may be selected by one skilled in this field.

The server computer 102, via PMAM 112 at block 204, in response to receiving the ISPM 106, determines an Initial Conveyance Duration “ICD” associated with conveyance of the ISPM by a known presenter. According to aspects of the invention, the ICD represents the sum of expected durations required for the presenter to convey all topic-relevant components 502, 504, 506, 508 (e.g., excluding non-topic-related content 510) of the ISPM 106. In particular, the ICD=[(total words spokenₜₑₓₜ+total words spoken_{images})]*[words spokenₚᵣₑₛₑₙₜₑᵣ/min]. It is noted that the PMAM 112 obtains presenter-dependent values to compute ICD from presenter metadata 109 and It is noted that the server computer 102 applies Machine Learning models available to the server computer to generate the additional values needed to determine the ICD, as described below.

According to aspects of the invention, the PMAM 112 has access to metadata 109 associated with the expected presenter needed to calculate a words spokenₚᵣₑₛₑₙₜₑᵣ/min for the expected speaker (e.g., details regarding relevant delivery speaking patterns, typical per-word speaking pace or cadence, number of words typically spoken to convey written words (e.g., a text ratio indicating whether the speaker reads slide text content verbatim, whether the speaker provides a general overview of slide text content, whether the speaker combines these approaches, etc.), length of time required to describe regions of importance with images of various size and composition, etc.) According to aspects of the invention, relevant speaker metadata may be extracted from historic content delivered by the speaker during previous relevant public speaking engagements; relevant metadata may also be extracted from diagnostic content provided by the speaker for the assessment purposes. In some cases (e.g., such as when no speaker metadata is available, when a speaker identity is unknown or is not yet confirmed, etc.), the PMAM 112 will use stored nominal values to estimate an ICD associated with the initial set of presentation material 106.

According to aspects of the invention, the PMPM 112 applies a Natural Language Processing classification model to identify all instances 400 of reference text 402 associated with the identified domain 522 within the ISPM 106 and to extract a total word count for the identified instances. The PMAM 112 then calculates total words spokenₜₑₓₜ=[(total reference words 404 for all instances 400 of reference text 402)*(spoken wordₚᵣₑₛₑₙₜₑᵣ/reference word)].

According to aspects of the invention, the PMAM 112 applies a Deep Learning (DL) object recognition algorithm (e.g., application of a DL object localization model available to the server computer 102 to identify the presence and location of discrete image portions 502, 504, 506, 508, 510 within a reference image 500; application of an DL image classification model available to the server computer to classify objects in reference images to reveal domain-relevant image portions 502, 504, 506, 508; and application of a DL object segmentation model to highlight pixels associated with the domain-relevant image portions 502, 504, 506, 508) to identify all relevant image portions with the ISPM). The PMAM 112 then calculates total words spoken_{images}=[total domain-relevant image portions]*(words spokenₚᵣₑₛₑₙₜₑᵣ/image portion)].

The server computer 102 receives, at block 206, Target Presentation Duration “TPD” 108 from a target duration source available to the computer. Although it is noted that aspects of the invention are especially useful when the TPD is different from the ICD, this is not required, as content refactoring (e.g., text summarization, image portion highlighting, and other aspects of invention embodiments selected by those skilled in this field) may be useful in some settings, even without expecting desired changes in presentation duration. It is noted that aspects of the invention will revise an ISPM 106 to generate a revised set of presentation material suited to accommodate a TPD shorter than the reference duration (e.g., such as when available time for a presentation has been reduced from an original allotment of time), as well as target durations that are longer than the reference duration (e.g., such as when available time for a presentation has been increased from an original allotment of time).

The server computer 102, via PCAM 114 at block 208, determines a Presentation Conversion Value “PCV” 116 by comparing the ICD and TPD. According to aspects of the invention, the PCV represents a ratio of the TPD 108 and ICD (e.g., TPD/ICD). In an embodiment, the PCAM 114 considers a received Presentation Density Value “PDV” 110 to accommodate an indicated preference for a discussion period, Q&A session, etc. to be included within the TPD. In particular, the PDV 110 represents a portion (e.g., a desired percentage) of the TPD 108 to be occupied by the conveyance of refactored presentation material, thereby indicating how the time allotted to the TPD 121 should be divided (e.g., earmarked for a structured conveyance period 602 and a less-structured, complementary discussion period 604, as shown schematically in FIG. 6). As an illustrative, non-limiting example, the server computer 102, having received a PDV 110 of 75% would, during a 60-minute total time slot (e.g., TPD 108), generate revised presentation material suitable for conveyance by a relevant presenter in a 45 minute structured presentation period 602, leaving 15 minutes for non-structured period 604 (e.g., for discussion, Q&A, etc.).

The server computer 102 applies, at block 210, a Machine Learning (ML) refactoring routine to revise the ISPM in accordance, at least partially, with the presentation conversion value, thereby generating a revised set of presentation material having a revised conveyance duration substantially equivalent to a preselected portion of a target duration. According to aspects of the invention, the preselected portion 602 of the target presentation duration TPD 108 coincides with the Presentation Density Value “PDV” (e.g. if the PDV is 75%, the portion of the Target Presentation Duration reserved for conveyance of the revised materials is 75% of the Target Presentation Duration.

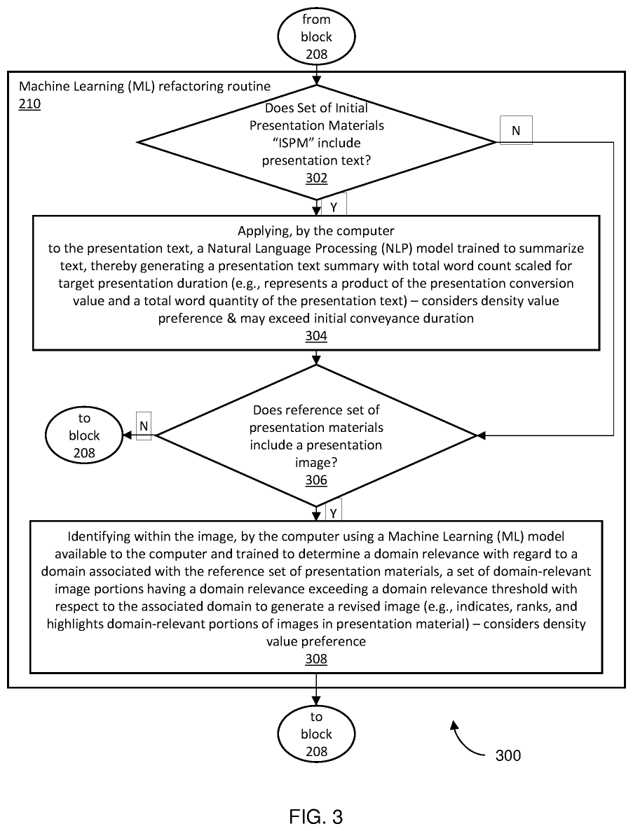

According to an aspect of the invention, with additional reference the FIG. 3, the server computer 102, determines at block 302 via the PMAM 112, whether the ISPM 106 contains presentation text to be revised, and flow skips to block 306, if no text to process is present. If text 402 to process is present, flow continues to block 304.

The server computer 102 applies to the identified reference text 402, via TRM 116 at block 304, a Natural Language Processing (NLP) model trained to provide a summary of desired length for provided text 402 to generate revised text (e.g., a summary) of shorter length 402′ (or longer 402″) than the reference text. According to aspects of the invention, the summary word count represents a product of the presentation conversion value PCV (e.g., considering density value preference DPV) and a total word quantity 404 of the reference text 402.) According to some aspects of the invention, the conveyance duration of summaries, (e.g., as in summary 404″, shown schematically in FIG. 4C, for which the PCV is greater than one) may exceed initial conveyance duration, allowing aspects of the present invention to be suited for scenarios in which an allotted time slot is extended beyond an initial duration (e.g., such as when a revised material is being presentation when another presentation has been cancelled or shortened). It is also possible for the summary to have a word count equal to the reference word count 404. It is noted that a shorter-than-reference-text summary 402′ my be generated using extractive NLP summarization methods and abstractive NLP summarization methods, selected according to the judgement of one skilled in this field. When a longer-than-reference-text summary 402′ is preferred, abstractive NLP summarization methods are especially suitable.

The server computer 102 determines at block 306, via continued application of PMAM 112, whether the ISPM 106 contains a reference image 500 to be revised, and flow returns to block 212 (in FIG. 2), if no reference image is present. If reference image 500 to process is present, flow continues to block 308.

The server computer 102 applies to a reference image 500, via IRM 118 at block 308, identifying, as described above, and shown schematically with combined reference to FIG. 5A, FIG. 5B, FIG. 5C, FIG. 5D, within the image, using a Machine Learning (ML) model available to the computer and trained to determine a domain relevance with regard to the domain 522 associated with the ISPM 106, a set of domain-relevant image portions 502, 504, 506, 508 having a domain relevance exceeding a domain relevance threshold with respect to the associated domain, generating a revised image 500′, 500″ that, according to aspects of the invention indicates, ranks, and highlights domain-relevant image portions. Flow continues to block 212 (in FIG. 2).

The server computer 102 combines at block 310, via Revised Content Assembly Module “RCAM” 120, revised presentation text (e.g., reference text summaries 404′, 404″) with reformatted images 500′, 500″ (e.g., having highlighted and ranked portions) to generate revised set of presentation materials into a Revised Set of Presentation Materials RSPM.

The server computer 102 provides at block 214, via Revised Presentation Material Delivery Module “RPMDM” 122 a revised set of presentation material “RSPM” to presenters or other users. According to aspects of the invention, the RPMDM 122 may be a user interface, storage component, or other transference device selected by one of skill in this field.

Regarding the flowcharts and block diagrams, the flowchart and block diagrams in the Figures of the present disclosure illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

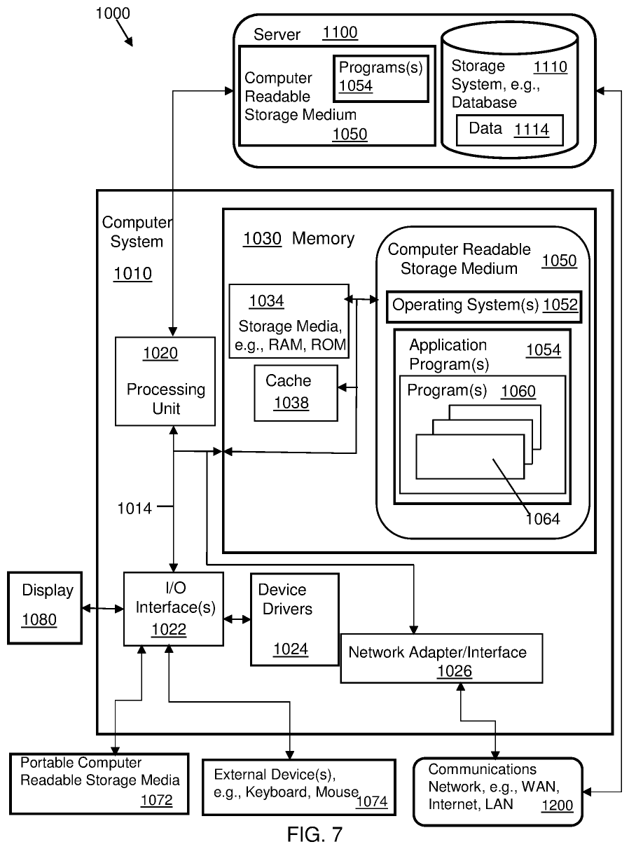

Referring to FIG. 7, a system or computer environment 1000 includes a computer diagram 1010 shown in the form of a generic computing device. The method of the invention, for example, may be embodied in a program 1060, including program instructions, embodied on a computer readable storage device, or computer readable storage medium, for example, generally referred to as memory 1030 and more specifically, computer readable storage medium 1050. Such memory and/or computer readable storage media includes non-volatile memory or non-volatile storage. For example, memory 1030 can include storage media 1034 such as RAM (Random Access Memory) or ROM (Read Only Memory), and cache memory 1038. The program 1060 is executable by the processor 1020 of the computer system 1010 (to execute program steps, code, or program code). Additional data storage may also be embodied as a database 1110 which includes data 1114. The computer system 1010 and the program 1060 are generic representations of a computer and program that may be local to a user, or provided as a remote service (for example, as a cloud based service), and may be provided in further examples, using a website accessible using the communications network 1200 (e.g., interacting with a network, the Internet, or cloud services). It is understood that the computer system 1010 also generically represents herein a computer device or a computer included in a device, such as a laptop or desktop computer, etc., or one or more servers, alone or as part of a datacenter. The computer system can include a network adapter/interface 1026, and an input/output (I/O) interface(s) 1022. The I/O interface 1022 allows for input and output of data with an external device 1074 that may be connected to the computer system. The network adapter/interface 1026 may provide communications between the computer system a network generically shown as the communications network 1200.

The computer 1010 may be described in the general context of computer system-executable instructions, such as program modules, being executed by a computer system. Generally, program modules may include routines, programs, objects, components, logic, data structures, and so on that perform particular tasks or implement particular abstract data types. The method steps and system components and techniques may be embodied in modules of the program 1060 for performing the tasks of each of the steps of the method and system. The modules are generically represented in the figure as program modules 1064. The program 1060 and program modules 1064 can execute specific steps, routines, sub-routines, instructions or code, of the program.

The method of the present disclosure can be run locally on a device such as a mobile device, or can be run a service, for instance, on the server 1100 which may be remote and can be accessed using the communications network 1200. The program or executable instructions may also be offered as a service by a provider. The computer 1010 may be practiced in a distributed cloud computing environment where tasks are performed by remote processing devices that are linked through a communications network 1200. In a distributed cloud computing environment, program modules may be located in both local and remote computer system storage media including memory storage devices.

The computer 1010 can include a variety of computer readable media. Such media may be any available media that is accessible by the computer 1010 (e.g., computer system, or server), and can include both volatile and non-volatile media, as well as removable and non-removable media. Computer memory 1030 can include additional computer readable media in the form of volatile memory, such as random access memory (RAM) 1034, and/or cache memory 1038. The computer 1010 may further include other removable/non-removable, volatile/non-volatile computer storage media, in one example, portable computer readable storage media 1072. In one embodiment, the computer readable storage medium 1050 can be provided for reading from and writing to a non-removable, non-volatile magnetic media. The computer readable storage medium 1050 can be embodied, for example, as a hard drive. Additional memory and data storage can be provided, for example, as the storage system 1110 (e.g., a database) for storing data 1114 and communicating with the processing unit 1020. The database can be stored on or be part of a server 1100. Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus 1014 by one or more data media interfaces. As will be further depicted and described below, memory 1030 may include at least one program product which can include one or more program modules that are configured to carry out the functions of embodiments of the present invention.

The method(s) described in the present disclosure, for example, may be embodied in one or more computer programs, generically referred to as a program 1060 and can be stored in memory 1030 in the computer readable storage medium 1050. The program 1060 can include program modules 1064. The program modules 1064 can generally carry out functions and/or methodologies of embodiments of the invention as described herein. The one or more programs 1060 are stored in memory 1030 and are executable by the processing unit 1020. By way of example, the memory 1030 may store an operating system 1052, one or more application programs 1054, other program modules, and program data on the computer readable storage medium 1050. It is understood that the program 1060, and the operating system 1052 and the application program(s) 1054 stored on the computer readable storage medium 1050 are similarly executable by the processing unit 1020. It is also understood that the application 1054 and program(s) 1060 are shown generically, and can include all of, or be part of, one or more applications and program discussed in the present disclosure, or vice versa, that is, the application 1054 and program 1060 can be all or part of one or more applications or programs which are discussed in the present disclosure.

One or more programs can be stored in one or more computer readable storage media such that a program is embodied and/or encoded in a computer readable storage medium. In one example, the stored program can include program instructions for execution by a processor, or a computer system having a processor, to perform a method or cause the computer system to perform one or more functions.

The computer 1010 may also communicate with one or more external devices 1074 such as a keyboard, a pointing device, a display 1080, etc.; one or more devices that enable a user to interact with the computer 1010; and/or any devices (e.g., network card, modem, etc.) that enables the computer 1010 to communicate with one or more other computing devices. Such communication can occur via the Input/Output (I/O) interfaces 1022. Still yet, the computer 1010 can communicate with one or more networks 1200 such as a local area network (LAN), a general wide area network (WAN), and/or a public network (e.g., the Internet) via network adapter/interface 1026. As depicted, network adapter 1026 communicates with the other components of the computer 1010 via bus 1014. It should be understood that although not shown, other hardware and/or software components could be used in conjunction with the computer 1010. Examples, include, but are not limited to: microcode, device drivers 1024, redundant processing units, external disk drive arrays, RAID systems, tape drives, and data archival storage systems, etc.

It is understood that a computer or a program running on the computer 1010 may communicate with a server, embodied as the server 1100, via one or more communications networks, embodied as the communications network 1200. The communications network 1200 may include transmission media and network links which include, for example, wireless, wired, or optical fiber, and routers, firewalls, switches, and gateway computers. The communications network may include connections, such as wire, wireless communication links, or fiber optic cables. A communications network may represent a worldwide collection of networks and gateways, such as the Internet, that use various protocols to communicate with one another, such as Lightweight Directory Access Protocol (LDAP), Transport Control Protocol/Internet Protocol (TCP/IP), Hypertext Transport Protocol (HTTP), Wireless Application Protocol (WAP), etc. A network may also include a number of different types of networks, such as, for example, an intranet, a local area network (LAN), or a wide area network (WAN).

In one example, a computer can use a network which may access a website on the Web (World Wide Web) using the Internet. In one embodiment, a computer 1010, including a mobile device, can use a communications system or network 1200 which can include the Internet, or a public switched telephone network (PSTN) for example, a cellular network. The PSTN may include telephone lines, fiber optic cables, transmission links, cellular networks, and communications satellites. The Internet may facilitate numerous searching and texting techniques, for example, using a cell phone or laptop computer to send queries to search engines via text messages (SMS), Multimedia Messaging Service (MMS) (related to SMS), email, or a web browser. The search engine can retrieve search results, that is, links to websites, documents, or other downloadable data that correspond to the query, and similarly, provide the search results to the user via the device as, for example, a web page of search results.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be accomplished as one step, executed concurrently, substantially concurrently, in a partially or wholly temporally overlapping manner, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

It is to be understood that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported, providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based email). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure that includes a network of interconnected nodes.

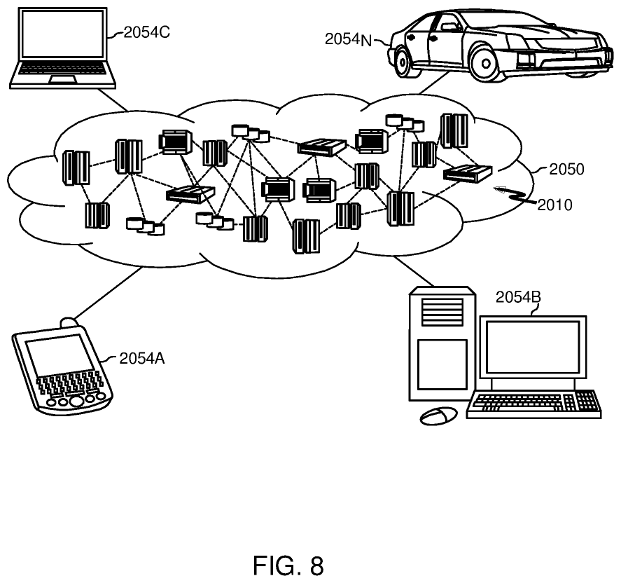

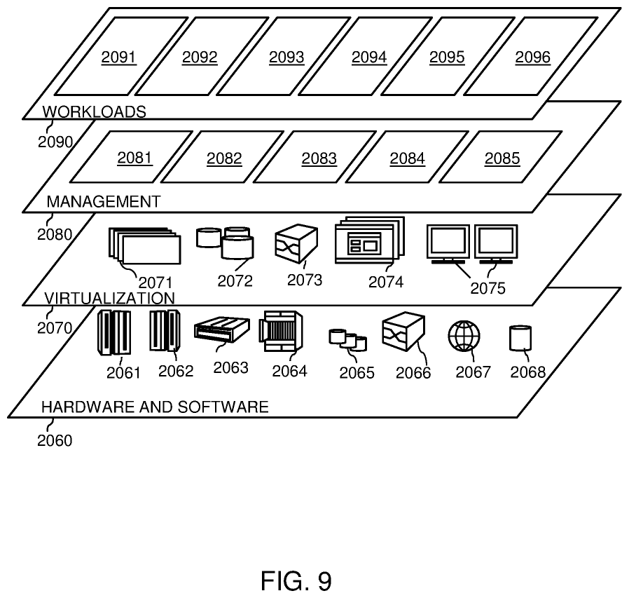

Referring now to FIG. 8, illustrative cloud computing environment 2050 is depicted. As shown, cloud computing environment 2050 includes one or more cloud computing nodes 2010 with which local computing devices used by cloud consumers, such as, for example, personal digital assistant (PDA) or cellular telephone 2054A, desktop computer 2054B, laptop computer 2054C, and/or automobile computer system 2054N may communicate. Nodes 2010 may communicate with one another. They may be grouped (not shown) physically or virtually, in one or more networks, such as Private, Community, Public, or Hybrid clouds as described hereinabove, or a combination thereof. This allows cloud computing environment 2050 to offer infrastructure, platforms and/or software as services for which a cloud consumer does not need to maintain resources on a local computing device. It is understood that the types of computing devices 2054A-N shown in FIG. 9 are intended to be illustrative only and that computing nodes 2010 and cloud computing environment 2050 can communicate with any type of computerized device over any type of network and/or network addressable connection (e.g., using a web browser).

Referring now to FIG. 9, a set of functional abstraction layers provided by cloud computing environment 2050 (FIG. 8) is shown. It should be understood in advance that the components, layers, and functions shown in FIG. 9 are intended to be illustrative only and embodiments of the invention are not limited thereto. As depicted, the following layers and corresponding functions are provided:

Hardware and software layer 2060 includes hardware and software components. Examples of hardware components include: mainframes 2061; RISC (Reduced Instruction Set Computer) architecture based servers 2062; servers 2063; blade servers 2064; storage devices 2065; and networks and networking components 2066. In some embodiments, software components include network application server software 2067 and database software 2068.

Virtualization layer 2070 provides an abstraction layer from which the following examples of virtual entities may be provided: virtual servers 2071; virtual storage 2072; virtual networks 2073, including virtual private networks; virtual applications and operating systems 2074; and virtual clients 2075.

In one example, management layer 2080 may provide the functions described below. Resource provisioning 2081 provides dynamic procurement of computing resources and other resources that are utilized to perform tasks within the cloud computing environment. Metering and Pricing 2082 provide cost tracking as resources are utilized within the cloud computing environment, and billing or invoicing for consumption of these resources. In one example, these resources may include application software licenses. Security provides identity verification for cloud consumers and tasks, as well as protection for data and other resources. User portal 2083 provides access to the cloud computing environment for consumers and system administrators. Service level management 2084 provides cloud computing resource allocation and management such that required service levels are met. Service Level Agreement (SLA) planning and fulfillment 2085 provide pre-arrangement for, and procurement of, cloud computing resources for which a future requirement is anticipated in accordance with an SLA.

Workloads layer 2090 provides examples of functionality for which the cloud computing environment may be utilized. Examples of workloads and functions which may be provided from this layer include: mapping and navigation 2091; software development and lifecycle management 2092; virtual classroom education delivery 2093; data analytics processing 2094; transaction processing 2095; and automatically adjusting presentation material to accommodate a duration different than an initial conveyance duration 2096.

The descriptions of the various embodiments of the present invention have been presented for purposes of illustration, but are not intended to be exhaustive or limited to the embodiments disclosed. Likewise, examples of features or functionality of the embodiments of the disclosure described herein, whether used in the description of a particular embodiment, or listed as examples, are not intended to limit the embodiments of the disclosure described herein, or limit the disclosure to the examples described herein. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

1. A computer implemented method of adjusting a set of
presentation materials, comprising:
receiving, by a computer, from a source available to the computer, an initial set of presentation materials;
responsive to receiving the initial set of presentation materials, determining by the computer, a reference presentation duration associated therewith;
receiving, by the computer, a target presentation duration from a target duration source available to the computer;
determining, by the computer, a presentation conversion value representing, at least in part, a ratio of the target presentation duration to the reference presentation duration; and
applying, by the computer, a Machine Learning (ML) refactoring routine to revise the initial set of presentation materials in accordance, at least partially, with the presentation conversion value, thereby generating a refactored set of presentation materials having a revised conveyance duration equivalent to the target duration.

2. The method of claim 1, wherein:
the initial set of presentation materials includes a corpus of presentation text;
wherein, the refactoring routine includes applying to the corpus of presentation text, a Natural Language Processing (NLP) model trained to summarize text, thereby generating a presentation text summary; and
wherein, the refactored set of presentation materials includes the presentation text summary.

3. The method of claim of 2, wherein:
the summary has a total word quantity based, at least in part, on a product of the presentation conversion value and a total word quantity of the presentation text.

4. The method of claim of 2, wherein:
the revised conveyance duration is longer than the target duration; and
wherein the NLP model includes an abstractive summarization algorithm.

5. The method of claim of 1, wherein:
the content includes an image; and
wherein the refactoring routine includes:
identifying within the image, by the computer using a Machine Learning (ML) model available to the computer and trained to determine a domain relevance with regard to a domain associated with the initial set of presentation materials, a set of domain-relevant image portions having a domain relevance exceeding a domain relevance threshold with respect to the associated domain; and
responsive to identifying the set of domain-relevant image portions, ranking the domain-relevant image portions in accordance with, at least partially, associated domain relevance, and generating a refactored image that includes a representation of the ranking, whereby the refactored set of presentation materials includes a representation of the ranking.

6. The method of claim of 5, wherein:
the refactoring routine includes identifying, within the set of domain-relevant image portions, a focus group of most-domain-relevant portions having a quantity substantially equal to a product of the presentation conversion value and a total quantity of domain-relevant portions.

7. The method of claim 1, further including:
further receiving a presentation density value; and
wherein the presentation conversion value further represents a product of the presentation density value and the ratio of the target presentation duration to the reference presentation duration, whereby the revised conveyance duration accommodates a discussion period within the target duration.

8. A system to adjust a set of presentation materials, which comprises:
a computer system comprising a computer readable storage medium having program instructions embodied therewith, the program instructions executable by a computer to cause the computer to:
receive, from a source available to the computer, an initial set of presentation materials;
responsive to receiving the initial set of presentation materials, determining by the computer, a reference presentation duration associated therewith;
receive a target presentation duration from a target duration source available to the computer;
determine a presentation conversion value representing, at least in part, a ratio of the target presentation duration to the reference presentation duration; and
apply a Machine Learning (ML) refactoring routine to revise the initial set of presentation materials in accordance, at least partially, with the presentation conversion value, thereby generating a refactored set of presentation materials having a revised conveyance duration equivalent to the target duration.

9. The system of claim 8, wherein:
the initial set of presentation materials includes a corpus of presentation text;
wherein, the refactoring routine includes applying to the corpus of presentation text, a Natural Language Processing (NLP) model trained to summarize text, thereby generating a presentation text summary; and
wherein, the refactored set of presentation materials includes the presentation text summary.

10. The system of claim of 9, wherein:
the summary has a total word quantity based, at least in part, on a product of the presentation conversion value and a total word quantity of the presentation text.

11. The system of claim 9, wherein:
the revised conveyance duration is longer than the target duration; and
wherein the NLP model includes an abstractive summarization algorithm.

12. The system of claim 8, wherein:
the content includes an image; and
wherein the refactoring routine includes:
identifying within the image, by the computer using a Machine Learning (ML) model available to the computer and trained to determine a domain relevance with regard to a domain associated with the initial set of presentation materials, a set of domain-relevant image portions having a domain relevance exceeding a domain relevance threshold with respect to the associated domain; and
responsive to identifying the set of domain-relevant image portions, ranking the domain-relevant image portions in accordance with, at least partially, associated domain relevance, and generating a refactored image that includes a representation of the ranking, whereby the refactored set of presentation materials includes a representation of the ranking.

13. The system of claim of 12, wherein:
the refactoring routine includes identifying, within the set of domain-relevant image portions, a focus group of most-domain-relevant portions having a quantity substantially equal to a product of the presentation conversion value and a total quantity of domain-relevant portions.

14. The system of claim 8, further including:
further receiving a presentation density value; and
wherein the presentation conversion value further represents a product of the presentation density value and the ratio of the target presentation duration to the reference presentation duration, whereby the revised conveyance duration accommodates a discussion period within the target duration.

15. A computer program product to adjust a set of presentation materials, the computer program product comprising a computer readable storage medium having program instructions embodied therewith, the program instructions executable by a computer to cause the computer to:
receive, from a source available to the computer, an initial set of presentation materials;
responsive to receiving the initial set of presentation materials, determining by the computer, a reference presentation duration associated therewith;
receive a target presentation duration from a target duration source available to the computer;
determine a presentation conversion value representing, at least in part, a ratio of the target presentation duration to the reference presentation duration; and
apply a Machine Learning (ML) refactoring routine to revise the initial set of presentation materials in accordance, at least partially, with the presentation conversion value, thereby generating a refactored set of presentation materials having a revised conveyance duration equivalent to the target duration.

16. The computer program product of claim 15, wherein:
the initial set of presentation materials includes a corpus of presentation text;
wherein, the refactoring routine includes applying to the corpus of presentation text, a Natural Language Processing (NLP) model trained to summarize text, thereby generating a presentation text summary; and
wherein, the refactored set of presentation materials includes the presentation text summary.

17. The computer program product of claim of 16, wherein:
the summary has a total word quantity based, at least in part, on a product of the presentation conversion value and a total word quantity of the presentation text.

18. The computer program product of claim 15, wherein:
the content includes an image; and
wherein the refactoring routine includes:
identifying, using the computer, within the image, by the computer using a Machine Learning (ML) model available to the computer and trained to determine a domain relevance with regard to a domain associated with the initial set of presentation materials, a set of domain-relevant image portions having a domain relevance exceeding a domain relevance threshold with respect to the associated domain; and
responsive to identifying the set of domain-relevant image portions, ranking using the computer, the domain-relevant image portions in accordance with, at least partially, associated domain relevance, and generating a refactored image that includes a representation of the ranking, whereby the refactored set of presentation materials includes a representation of the ranking.

19. The computer program product of claim 18, wherein:
the refactoring routine includes identifying, using the computer, within the set of domain-relevant image portions, a focus group of most-domain-relevant portions having a quantity substantially equal to a product of the presentation conversion value and a total quantity of domain-relevant portions.

20. The computer program product of claim 15, further including:
further receiving a presentation density value; and
wherein the presentation conversion value further represents a product of the presentation density value and the ratio of the target presentation duration to the reference presentation duration, whereby the revised conveyance duration accommodates a discussion period within the target duration.
